(19) United States
(12) Patent Application Publication
(10) Pub. No.: US 2004/0133499 A1
(43) Pub. Date: Jul. 8, 2004

(54) Method for paying paid offers made on a network

(76) Inventors: Ulrich Mitreuter, Konigsdorf (DE); Renate Zygan-Maus, Munchen (DE)

Correspondence Address: MORRISON & FOERSTER LLP, 1650 TYSONS BOULEVARD, SUITE 300, MCLEAN, VA, 22102, US

(21) Appl. No.: 10/433,949

(22) PCT Filed: Feb. 28, 2002
(86) PCT No.: PCT/EP02/02182

(30) Foreign Application Priority Data
Mar. 2, 2001 (EP) 01105176.0

(51) Int. Cl. G06F 17/60

(52) U.S. Cl. 705/37

(57) ABSTRACT

The invention enables an Internet user to pay for paid offers that he receives and accepts with his computer via his Internet access using his Internet access account.

Method for paying paid offers made on a network

1. Which technical problem is to be resolved by your invention?

2. How was this problem resolved previously?

3. In what technical way does your invention resolve the specified technical problem (specify its benefits)?

4. What is a special feature of the invention?

5. Exemplary embodiment(s) of the invention.

### RE. POINT 1: WHICH TECHNICAL PROBLEM IS TO BE RESOLVED BY YOUR INVENTION

It should be possible for an Internet user to pay for paid offers (e.g. data or information provision offers, mail order offers etc.) that he receives and accepts with a PC via his Internet access (and even if the offers are not made by his own Internet access provider).

### RE. POINT 2: HOW WAS THIS PROBLEM RESOLVED PREVIOUSLY

Since payment processes on the Internet, which are based on the (end-to-end) identification and authentication of the buyer (=Internet user) using their credit card number or certificates, require a relatively high level of technical and organizational effort, it would be desirable (in particular for downloading electronic information from the Internet, but also for ordering of other goods (in particular goods for which the price lies within the framework of the monthly Internet access charges), to allow payment to be made via the Internet access service.

No previous implementations of payment for offers that are not made by Internet access providers themselves using the Internet access bill are known.

### RE. POINT 3: IN WHAT TECHNICAL WAY DOES YOUR INVENTION RESOLVE THE SPECIFIED TECHNICAL PROBLEM (SPECIFY ITS BENEFITS)

The inventive method is based on an Internet user identification in accordance with the “Method for network-wide identification of Internet users” described in the Annex. If the said Internet user identification method is used for the IP messages of the Internet user with which he transmits his desire to buy, the user's Internet access provider and the Internet user can be determined for offline billing. It is useful for billing to be undertaken via the user's Internet access provider who already has a business link with the user (collection service for the information seller):

A payment service provider makes available a special payment server via which the Internet user gives his agreement to the collection of the purchase amount and via which, in the case of an offer to provide data or information, the transmission of the paid data or information is undertaken and monitored. The data assigned to each payment transaction, in particular the Internet user identification data, the confirmed purchase amount, an identification for the information purchased and for the information seller is stored and forwarded offline for invoicing to the user's Internet access provider. The amount to be paid by the user is divided up between the information seller, the payment service provider and the user's Internet access provider in accordance with rules agreed beforehand.

The payment service provider may or may not be identical to the user's Internet access provider. A payment service provider that is not identical to the user's Internet access provider needs a trustworthy business relationship with the Internet access provider in order to make use of the collection of facilities of the Internet access provider, in which case the Internet access provider from a technical standpoint needs the Internet access service feature “identification of the Internet user”. The information seller is the customer of the payment service provider.

The advantages of this new method by comparison with other methods are as follows:

cheaper for the information seller than the credit card procedure

cheaper for the seller than the procedure using user-related, public certificates

more secure for the purchaser than the credit card procedure

the new method allows an independent (of the payment service provider) 3rd-party to record details of the TCP/IP-based information transmission process (TCP/IP addresses and port numbers used, time, duration, volume of data transmitted) for any subsequent checking required.

A variant of the method in which billing is undertaken by a payment service provider not identical to the user's Internet access provider is possible, in this case the Internet access provider makes no collection for the payment service provider but transfers to them on request the data necessary for billing (name, address of the Internet user).

### RE. POINT 4: WHAT IS A SPECIAL FEATURE OF THE INVENTION

A special feature of the invention lies in the use of the “simple method for network-wide identification of Internet users” described in the Annex in connection with a special payment service server so that it is possible, without a direct business link between the information provider and the purchaser, to buy and sell Internet information.

### RE. POINT 5: EXEMPLARY EMBODIMENT(S) OF THE INVENTION

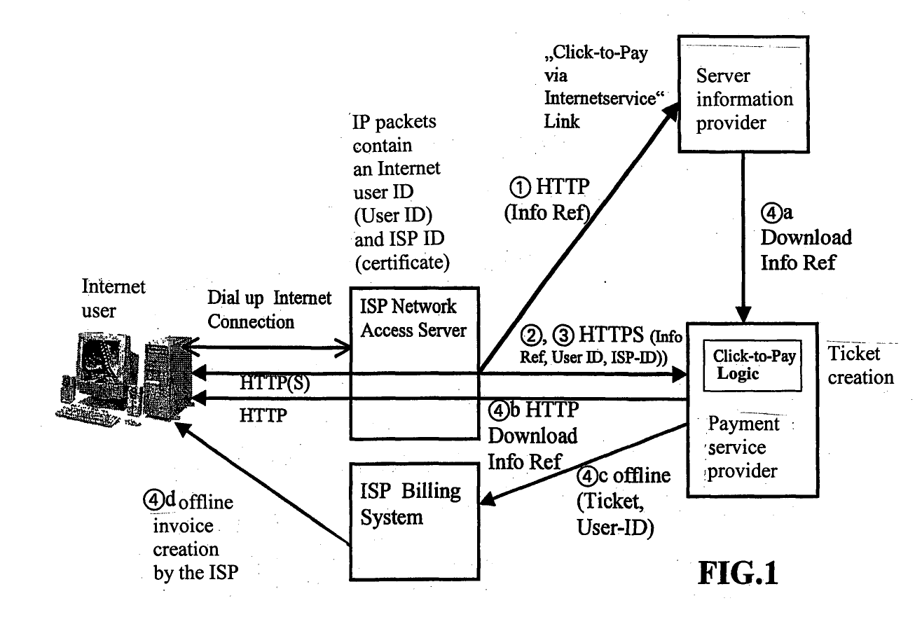

Execution sequence of the possible implementation of the inventive method (for more information see the corresponding numbered FIG. 1 which follows the procedure steps)

1. an Internet user with the Internet access service feature “identification of the Internet user” finds a Web page with an offer that is of interest to them. The owner of the Web page has built into The Web page a “click to pay by Internet service” button which the Internet user (identified via new IP protocol data) clicks on if they want to initiate the purchase of the information offered.

2. With standard Internet procedures (HTTP protocol) an HTTP connection is established between the PC of the Internet user and the server of the payment service provider by clicking on the button “click-to-pay via Internet service” (the address of the payment service provider is hidden behind the button, a normal Browser procedure). When this is done a reference to the selected paid information from the Web page of the seller/information provider is also transferred (standard service feature of HTTP).

3. The Server of the payment service provider asks the purchaser via HTTS whether they actually want to make this purchase at the specified price. For this HTTPS connection a server certificate is sufficient, the user does not need his own certificate.

4. When the purchaser confirms the purchase the server of the payment service provider creates a corresponding ticket that is fed offline into the creation of the Internet access bill. At the same time it establishes a TCP/IP connection to the server of the information provider via which it receives the requested information and forwards it to the purchaser's PC.

Each payment transaction, including an unsuccessful transaction, is logged by the server of the payment service provider. The customer of the payment service provider is the information provider who is using the Internet payment service.

Annex

Method for network-wide identification of Internet users

1. Which technical problem is to be resolved by your invention?

2. How was this problem resolved previously?

3. In what technical way does your invention resolve the specified technical problem (specify its benefits)?

4. What is a special feature of the invention?

### RE. POINT 1: WHICH TECHNICAL PROBLEM IS TO BE RESOLVED BY YOUR INVENTION

Internet access is currently offered for the mass market by the Internet access providers without the service feature “network-wide identification of the Internet user”. New Internet-based services however require an identification of the Internet user with respect to the service provider. This identification should also be protected against manipulation and misuse by another Internet user. E.g. Internet telephony services and Internet telephone network convergence services specify that the users of these services (i.e. the sender of the IP packets that contain the service signaling data) is not necessarily identical to the Internet service provider of the Internet user.

A network-wide introduction of the Internet user identification servers in accordance with the invention would significantly enhance trust in IP messages and very much address the spread of commercial applications with their potentially greater security requirements and help to combat Internet misuse.

### RE. POINT 2: HOW WAS THIS PROBLEM RESOLVED PREVIOUSLY

The methods previously known for the secure identification (authentication) of an Internet user all use the principle of end-to-end authentication. I.e. the communication partners authenticate themselves on the basis of identification and authentication data or which is individually assigned to each communication partner and is made known to the other communication partner. This data can either be

a) already known to the other communication partner before the beginning of communications (sufficient identification and authentication data are stored at the communication partner), or

b) are notified to the other communication partner at the beginning of communications with the aid of a trusted third-party (identification and authentication data are stored at a central public certification body).

Previously known procedures for the secure identification of an Internet user are as follows:

I. Identification and Authentication Via the IP Hosts Used by the Communication Partners: IPSEC

This procedure requires that both communication partners use static IP addresses and that these IP addresses are uniquely assigned to the two communication partners.

IPSEC is not suitable for the technical problem to be resolved here since

1. The majority of Internet users used dial-in access and only receive a temporary IP address assigned by their Internet access provider;

2. IPSEC as point-to-point method of type a) demands the storage of the identification and authentication data of all potential communications partners is thus unsuitable for the mass market of new Internet services.

II. Identification and Authentication by TCP Functions (TLS, Transport Layer Security)

This procedure can in principle be used by all application programs that use TCP/IP. It requires adaptations in the application programs as well as provision of end-to-end identification and authentication data either in accordance with principle a) or b).

III. Identification and Authentication by the Application Programs Used

The data to identify the user, e.g. his name, is transmitted in the application protocol (.e.g. HTTP, FTP, Telnet, SIP) in plain text. To prove that the sender is the bearer of name, i.e. for authentication of the name, there are a number of options. e.g.

1. A shared item of secret data, e.g. a password that is only known to the user and his communication partner, is transmitted in the application protocol or in the application user data. This method can only be used in combination with transmission that is secured (e.g. encrypted) against eavesdropping.

2. A shared item of secret data is used to encrypt a part of the message. With the recipient can decrypt the message the sender is authenticated as the owner of the encryption key.

3. The evidence that the user is the owner of a shared item of secret data is obtained by a challenge-response procedure in the application protocol.

4. A shared item of secret data is used to create a digital fingerprint of the message that is appended to the message. If this fingerprint can be reproduced by the recipient the sender is authenticated as the owner of the shared item of secret information.

5. The sender creates using their “private key” of a symmetrical authentication procedure a digital fingerprint of the message to be sent which is appended to the message and appends to the message an electronic certificate. This certificate contains the “Public Key” and the name of user. The recipient can verify the digital fingerprint with the aid of this public key. The recipient must now also verify the certificate. This is done in accordance with the standard procedure. This involves the certificate containing a digital fingerprint of the data of certificates, produced with the private key of the certification body. If the recipient possesses an public key of the certification body he can check the integrity of the user's certificate. The ownership of the private key which was used to create the digital fingerprint of the message authenticates the user.

The disadvantage of all known procedures is the great effort for installation, administration and maintenance of different databases containing identification and authentication data of the Internet users (either central, expensive certificate depots or many subscriber databases at various service providers) as well as in management of the infrastructure that is intended to insure the integrity of the identification data (e.g. certificate revocation lists, security policy database). This expense arises because each Internet user has to perform the identification and authentication procedure themselves (principle of end-to-end authentication).

### RE. POINT 3: IN WHAT TECHNICAL WAY DOES YOUR INVENTION RESOLVE THE SPECIFIED TECHNICAL PROBLEM (SPECIFY ITS BENEFITS)

On request the Internet access provider provides IP messages of his customers with data which allows identification of the IP packages of the Internet user. The Internet access provider guarantees the integrity of this data with cryptographic means.

The difference from the known methods mentioned above thus lies in the fact that the Internet user no longer initiates his identification himself but that the Internet access provider takes over this task. The effort for identification of IP packets of Internet users is reduced by the invention.

The requirement for the new identification and authentication method in accordance with the invention is that the Internet access provider maintains a business relationship with the Internet user. This means that he possesses data that can identify the Internet user. If the Internet user makes use of the access service of the Internet access provider (e.g. when establishing an Internet connection via the telephone line) they must authenticate themselves to the Internet access provider at the beginning (typically with an account name and a password that the Internet access provider has stored). After the authentication the identity of the Internet user is thus securely known to the Internet access provider. He can now insert into all IP packets of the Internet user the information which identifies the Internet user. With this information the IP packets of the Internet user can be identified by other Internet service providers without the Internet user having to provide their own identification data, and either in accordance with principle a), i.e. the service provider must themselves store and administer the Internet user-specific data or in accordance with principle b), i.e. with the aid of a central certification body).

An analogy from the public switching telephone network PSTN should illustrate the idea. When a call is established in the telephone network the directory number of the calling subscriber is used by the telephone network. The operator of the telephone network guarantees that this number really identifies the telephone of the calling number, the directory number of the calling subscriber is “network provided” or “user-provided, and verified and passed”. The calling subscriber is not in a position to change the number since it is used by the network and not by the Subscriber. Other telephone network subscribers cannot change this number either. Thus it is always possible to securely identify the telephones taking part in a telephone call.

In the IP network this is not possible since firstly the sender IP address can be corrupted in the IP messages and secondly the IP addresses of the Internet users are only made available temporarily. In accordance with the invention in an IP network the Internet access provider as a trustworthy body can however provide the IP message for security against corruption with information used by the network to identify the Internet user.

The invention uses the usual point-to-point Internet user identification between the Internet user and his Internet access provider for Internet access in order to provide a secure identification of an Internet user network-wide via a trustworthy Internet access provider(equipped with a public certificate).

### RE POINT 4: EXEMPLARY EMBODIMENT(S) OF THE INVENTION

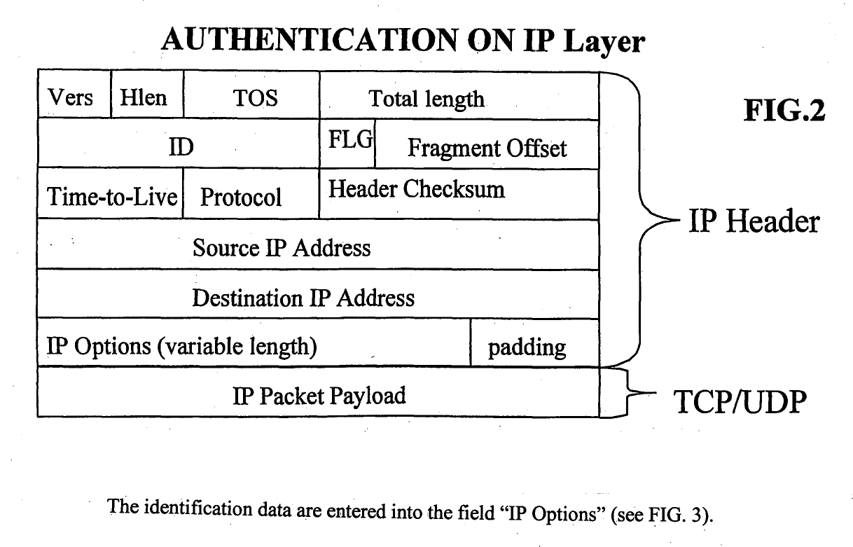

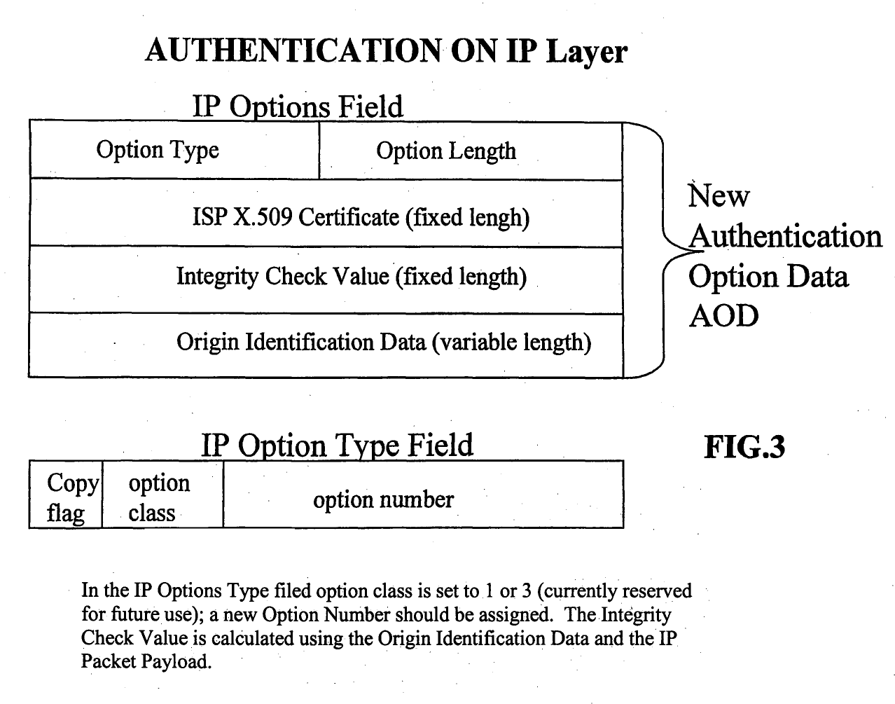

For a generic solution (solution which is independent of the transport or application protocol used) with the best possible performance implementation at IP level is proposed (see FIGS. 2 and 3).

At the POP (Point-of-Presence, access node) of the Internet access provider

The IP packets are investigated to see whether a specific (still to be defined) flag, a so-called authentication request flag, is set, whereby for the Internet user an insertion of identification data per IP packet can be requested and/or

The system looks into a database (which possesses a similar function to the security policy database for IPSEC) to see if the service “provide IP packets with identification data” is requested for the Internet user. Selectors for this can be the destination IP address, the transport protocol or the TCP/UDP ports.

If yes, the Internet access provider adds the data that identifies the Internet user to the IP packet header. Typical possibilities are a telephone number of the Internet user or his user name that he uses for the subscription of his Internet access which is known to his Internet access provider.

The Internet access provider then forms, using the modified IP packets including the unchanged user data sent by the user, a digital signature to safeguard the identification data and the user data sent by the user against corruption (data integrity) To do this a checksum is calculated covering the modified IP packet and this is compared with the secret key of the ISP (integrity check value). Finally the Internet access provider inserts into the IP packet header his electronic certificate (ISP X.509 certificate) which contains the ISP's public key for decrypting the checksum. In this way each recipient of the IP message can check the digital signature for correctness by decrypting the checksum and comparing it with the checksum that the recipient has calculated. In addition the recipient has the option of reaching further data of the Internet user (name, address,) via the owner of the certificate (the Internet access provider) named in the certificate. (this could be used for malicious caller identification).

The suggested implementation has similarities with IPSEC. The significant difference here is that, by contrast to IPSEC, no point-to-point authentication but a point-to-multipoint authentication can be implemented since all the data relevant to authentication (the “name” of the Internet user, the name of the Internet access provider (ISP) and his certificate) are contained in the IP packet. In addition there is neither an end-to end nor a host-to-host authentication but an ISP-to-host authentication.

The realization of the Internet user identification at IP level requires a new optional function of the IP stack. If this function is not available in a recipient host, the entire new AOD information (see FIG. 3) of an IP and message is to be ignored. This function is already currently supported for unknown IP options by standard IP stacks.

Since the length of an IP message changes by insertion of the AOD information both the total length of field and also the header checksum of the IP header must be recalculated. The digital signature of the Internet access provider applies for as long as the data in the IP payload do not change.

It is possible that data in the IP payload can be changed on the route of the IP message to the actual communication partner, e.g. by authorized proxies (e.g., the VIA field for SIP, IP addresses for NAT). The proxy then recalculates both the TotalLength field and HeaderChecksum in the IP header.

In such a case the proxy can either already be the end host of the transmission safeguarded in accordance with the invention. But this is for example the case when the proxy performs authentication of the Internet user to check whether for example they are already a customer of the message recipient. The proxy checks the AOD and forwards the IP message without the AOD.

Or the proxy adapts the AOD information and signs these changes using a digital signature. To do this the proxy computes the integrity Check value and overwrites the previous value. In addition it replaces the ISP certificate by its certificate and expands the origin identification data by information that identifies the ISP.

The advantage of realization in the IP layer compared to a realization in the transport or application layer is that the Internet access provider in the POP can see very quickly which identification data is to be inserted or not since only the IP header has to be analyzed or the policy database interrogated to do this (performance benefit). The data of the higher protocol layers, that is exchanged end-to end is not changed. The applications on Internet hosts that use this new IP option need an expanded IP socket interface in order if necessary to set the authentication flag for the IP packet in the outgoing direction or to transfer sender identification data to the IP socket interface and to read sender identification data received in the incoming direction. The ISP that offers the new Internet access service feature “identification of Internet users” needs a policy database which must be administered. In addition the ISP needs a certificate of a public certification body himself which must also be administered and maintained (update of the certificate revocation lists etc.).

1. Method of paying paid offers made on a network, such that
the paid offer, about which the network user is informed via an offer server, is requested by a client of the networked user
the client is then notified by the offer server of a reference to the paid offer as well as to a payment server,
the said offer is then requested by the client from the said payment service server in which case the identity of the network user and of his network access provider are added to the request message from the network access server of the network user,
the rendering of the service offered in accordance with the offer is notified or executed by the said payment service server,
the fees for using the paid offer are recorded by the said payment service server,
on the basis of the said recorded fees an invoice is created by a billing system for the said network user:

2. Method according to claim 1
characterized in that the said billing system is the billing system of the network access provider

3. Method according to claim 1
characterized in that the said billing system is the billing system of the said payment service provider.

4. Method according to one of the claims 1 to 3
characterized in that
the service offered by the offer involves the provision of data or information,
he said data or information is downloaded from the network and via the said payment service server.
